(19) United States
(12) Patent Application Publication
(10) Pub. No.: US 2022/0007674 A1
(43) Pub. Date: Jan. 13, 2022

(54) FROZEN CONFECTIONERY COMPRISING A COATING COMPOSITION AND PROCESS FOR PRODUCING THE COATING COMPOSITION

(71) Applicant: SOCIETE DES PRODUiTS NESTLE S.A., Vevey (CH)

(72) Inventors: Marcel Aebi, Bakersfield, CA (US); Sravanti Pailiri, Bakersfield, CA (US); Guillermo E. Napoiitano, Dublin, OH (US); Sbaritha Nalur Chandrasekarari, Bakersfield, CA (US)

(21) Appl. No.: 17/293,976

(22) PCT Filed: Nov. 14, 2019
(86) PCT No.: PCT/EP2019/081408

§ 371 Date: May 14, 2021

Related U.S. Application Data
(60) Provisional application No. 62/767,871, filed on Nov. 15, 2018.

(51) Int. Cl. A23G 9/48; A23G 1/30; A23G 3/34; A23G 1/36; A23G 1/48; A23G 1/40; A23G 3/40; A23G 3/48; A23G 3/42; A23G 3/46; A23G 3/36

(52) U.S. Cl. CPC A23G 9/48; A23G 1/305; A23G 3/343; A23G 1/36; A23G 1/48; A23V 2002/00; A23G 3/40; A23G 3/48; A23G 3/42; A23G 3/46; A23G 3/362; A23G 1/40

(57) ABSTRACT

The invention relates to a composition for coating a frozen confectionery comprising a coating having a coating composition comprising, expressed in weight % (based on the total weight of the coating), 40-60 wt. %, preferably 43-60 wt. %, more preferably 45-50 wt. % of total fat in the coating, 30-50 wt. % of ground whole nuts having a particle size below 80 microns, preferably 10 to 73 microns, and wherein the total fat in the coating composition comprises 40-60 wt. % of liquid fat and 60-40 wt. % of hardening fat based on the total fat. The invention also relates to a method for making the coating composition.

### FIELD OF THE INVENTION

The present invention relates to a composition for coating a frozen confection, in particular to a composition for a nut-based coating. The invention also relates to a method for making the coating composition.

### BACKGROUND

Coated frozen confections are products, which are highly appreciated by consumers. Texture and nutritional profile of the coating are drivers for consumer preference.

Traditional ice cream coatings are chocolate based and use hard fats like cocoa butter to achieve the desired functionality of viscosity, setting and texture. Chocolate-based coatings may be decorated with nut pieces in the form of inclusions to provide flavor and a crunchy texture. These kind of coatings usually has a high level of saturated fatty acids (SFA).

Nut-based coating exist in confectionary but use only the nut meat and not the oil. This is because the oil is too soft and has a very low melting point. Applying the nut-based coating used in confectionary to a frozen confection raises a number of difficulties due to the soft products surface. For example, solidification of the coating has required a long setting time. Furthermore, packing the product without influencing coating appearance has been difficult.

Peanut butter is a well-known spread for bread etc. The peanut butter comprises milled nuts and hydrogenated oils to provide stability to the spread.

In frozen confections, there is a need for a coating with soft sensation or texture when consumed frozen. Furthermore, the coating needs to be usable on standard coating/dipping equipment used in industrial ice cream production. The coating also needs to set sufficiently before the product can be packed.

There is also a need for a healthy fat coating with low levels of saturated fatty acids.

There is a need to overcome at least some of the aforementioned problems and provide frozen confectionery coatings with desirable rheological properties in form of the setting properties whilst maintaining desired organoleptic properties of a “ganache”.

### OBJECT OF THE INVENTION

It is thus the object of present invention to provide a nut-based coating for frozen confectionery products, in particular with a soft texture.

A second object of the present invention is to provide a coating composition for frozen confectionery with acceptable processing characteristics.

### SUMMARY OF THE INVENTION

According to a first aspect the invention relates to a frozen confectionery comprising a coating having a coating composition comprising, expressed in weight % (based on the total weight of the coating),
40-60 wt. %, preferably 43-60 wt. %, more preferably 45-50 wt. % of total fat in the coating,
30-50 wt. % of ground whole nuts having a particle size below 80 microns, preferably 10-73 microns, and
wherein the total fat in the coating composition comprises 40-60 wt. % of liquid fat and 60-40 wt. % of hardening fat based on the total fat.

The present invention avoids the problems associated with nut-based coatings that are too hard or do not set properly on frozen confections and provides a fat based coating, which can be pre-manufactured and stored for use as needed.

It has been found that the coating has a good texture due to the mixture of solid and liquid material in the coating composition.

The coating obtained with the composition according to the invention has a soft sensation and taste similar to peanut butter with an option to have crunchy/grainy or creamy texture. In comparison to standard compound coatings used in frozen desserts with a snappy and crisp texture the present invention of peanut butter was found to be significantly more soft and chewy by a sensory panel.

According to a second aspect, the invention relates to a process for producing a coating composition, which can be applied on frozen confections with standard equipment, setting in acceptable time to a degree good enough for handling and packaging in a standard industrial line. The process for producing a coating composition as discussed above and in the claims comprises the steps:
providing ground whole nut,
providing the non-fat solids, the hardening fat, and the liquid oil,
melting the hardening fat,
mixing non-fat solids with the at least part of the melted hardening fat and
obtaining a mixture of fats, oils and non-fat solids, resulting in a paste,
refining the mixture of fats, oils and non-fat solids by milling to reduce the particle size, preferably to a particle size below 80 microns, preferably below 40 to 15 microns
adding remaining fats and oils to the refined mixture and
optionally adding emulsifier to the refined mixture and/or the mixture with fats and oils.

In a further aspect, the invention relates to the coating composition as such.

The invention also related to a frozen confectionery comprising a coating having a coating composition comprising, expressed in weight % (based on the total weight of the coating),
40-60 wt. %, preferably 43-60 wt. %, more preferably 45-50 wt. % of total fat in the coating,
30-50 wt. % of ground whole nuts having a particle size below 80 microns, preferably 10-73 microns, and providing 23-61 wt. % of the total fat in the coating composition and
77-39 wt. % of the total fat not originating from the ground whole nuts, which together with the fat from the ground nuts provides the total fat in the coating composition, and
wherein the total fat in the coating composition comprises 45-55% of liquid fat and 55-45 wt. % of hardening fat based on the total fat.

### BRIEF DESCRIPTION OF THE DRAWINGS

FIG. 1 shows the solid fat content (%) for temperatures between −40° C. and 40° C. for fat-based coating composition according the invention compared with other coatings.

FIGS. 2(a) and 2(b) show respectively the texture profile with time in a single penetration test at −22° C. and its peak hardness value (force, g) for fat-based coating according the invention compared with other coatings.

FIGS. 3(a) and 3(b) show respectively the texture profile with time in a single penetration test at −22° C. and its peak hardness value (force, g) for fat-based coating according the invention compared with a coating containing nuts that does not set.

FIG. 4 is a picture of a frozen confection according to the invention.

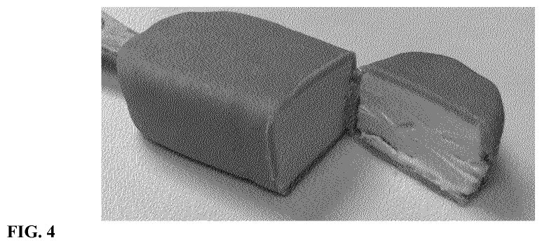

### DETAILED DESCRIPTION OF THE INVENTION

In a preferred embodiment of the invention, the frozen confectionery comprises a coating composition comprising ground whole nuts providing 23-61 wt. % of the total fat in the coating composition and
77-39 wt. % of the total fat not originating from the ground whole nuts together with the fat from the ground nuts providing the total fat in the coating composition.

Advantageously, in frozen confectionery according to the invention, the total fat in the coating composition comprises 45-55 wt. % of the liquid fat and 55-45 wt. % of hardening fat based on the total fat.

Without wishing to be bound by theory, it is believed that ground whole nuts, for example, peanuts, between 30-50 wt. % of the coating provides the necessary liquid oil to obtain the desired texture of a ganache type coating. On the other hand, the 77-39 wt. % of fat (based on the total fat) not originating from the ground nuts (preferably including milk fat, palm oil and its fractions, emulsifier, and in some cases, a structuring high-melting fat) are necessary to provide structure to the coating, maintaining its integrity and acting as a solid phase to retain the high proportion of liquid oil from the ground nuts, that will provide the suitable functionality for processing, handling and packaging of the finished product. Liquid and solid fat compositions outside the mentioned ranges have been found to fail to provide the desired textural attributes and/or negatively affect the setting time of the coating.

In a preferred embodiment of the invention, the frozen confectionery comprising a coating having a coating composition comprising, expressed in weight % (based on the total weight of the coating),
40-60 wt. %, preferably 43-60 wt. %, more preferably 45-50 wt. % of total fat in the coating,
30-50 wt. % of ground whole nuts having a particle size below 80 microns, preferably 10-73 microns, and providing 23-61 wt. % of the total fat in the coating composition and
77-39 wt. % of the total fat not originating from the ground whole nuts, which together with the fat from the ground nuts provides the total fat in the coating composition, and
wherein the total fat in the coating composition comprises 40-60 wt. % of liquid fat and 60-40 wt. % of hardening fat based on the total fat.

The above-mentioned coating composition may be based on peanuts.

Normally a coating formulated to be soft (such as a coating with soybean oil) would be too soft and would not set quickly enough in standard industrial filling/dipping line resulting in smear and uneven/drip covering of the surface. Further, the coating composition may not adhere sufficiently to the surface of the frozen product. Typically, the blend of oils used in a conventional coating is formulated to achieve a solid fat index of −70 at 0° C. to be a good coating, and this coating will be hard and brittle and will not have the needed soft texture.

The present invention provides a coating composition which comprises a fat blend with vegetable fat (preferably palm), with high content of liquid oil, preferably peanut oil. Additionally the blend may optionally comprise milk fat which due to its wide range of melting fractions provides textural benefit. Preferably, a seeding or structuring agent is used to aid the crystallization of the material. It is added in an amount sufficient to provide strength and faster crystallization kinetic properties to the coating. Examples of seeding or structuring agents are palm stearin or wax. Anhydrous milk fat brings a wider range of melting points and adds to the texture of the coating. Ground whole nuts added to the mix may aid the setting of the coating composition.

The coating composition may comprise a structuring agent selected from the group consisting of palm stearin, hydrogenated oils, a wax or a combination thereof.

Preferably, the ground whole nuts provide 14-23 wt. % of nut oil based on the total coating weight. This also corresponds to 1-2 wt. % of naturally occurring saturated fats. In a preferred embodiment of the invention, the ground whole nuts are peanuts.

In a preferred embodiment of the invention, the coating composition comprises 14-45 wt. % non-fat solids not coming from the nuts and 15-26 wt. % non-fat solids coming from the nuts based on the total coating weight. This provides a coating which is desirably nut-forward in flavor while being process friendly in standard conditions.

It has been found that when the total fat in the coating composition comprises 40-60 wt % of liquid fat and 60-40 wt. % of hardening fat based on the total fat provides a coating which shows good organoleptic and processing characteristics. A preferred coating composition with these properties comprises 45-55 wt. % of liquid fat and 55-45 wt. % of hardening fat.

In a particular preferred embodiment of the coating composition the total fat in the coating composition comprises 50% liquid oil and 50% hardening fat.

Advantageously, in the coating composition fat not originating from the ground nuts comprises 16-0 wt. % liquid oil and 30-20 wt. % of hardening fat based on total coating weight. This provides a desired ratio of liquid and hardening fat.

In a preferred embodiment of the coating composition, the coating composition comprises ground nuts combined with palm oil or coconut oil or a combination thereof.

In one embodiment of the invention the coating composition is free from hydrogenated oil.

If a structuring agent is used it is preferably present in an amount of between about 0.2% and 3% by weight of the coating. The structuring agent may be waxes such as bees wax, berry wax, carnauba wax and a plant-derived wax such as candelilla wax, berry wax and sunflower wax, or a combination thereof. The structuring agent may also be a high-melting point emulsifier or fully hydrogenated vegetable oil.

Other structuring agents are monoacylglycerol, diacylglycerol, monoacylglycerol ester, sorbitan fatty acid ester, behenic acid, or a combination thereof. These structuring agents are however, not preferred for all natural products.

It is preferred that the coating material is maintained at 32-46° C. to retain the optimal viscosity for regulating the pick-up weight and to enable a uniform and smooth coating on the finished product. The coating according to the invention typically sets well enough to be wrapped in approximately 15-60 seconds, preferably in approximately 15-30 seconds.

In the present context, the term “ground” means a reduction to fine particle size by grinding, milling, crushing, pounding and breaking up

In the present context, “whole nut” or “whole nuts” including “Peanuts” are the kernel or seed of their respective family of trees and plants without the flesh or shell and with or without skin and/or germ/heart

It is preferred that the ground whole nuts are selected from the group consisting of culinary nuts such as peanuts, almonds, brazil nuts, cashews, hazelnuts, pecans, walnuts, macadamia nuts, pistachio nuts, chest nuts, and mixtures thereof.

Examples of typical oil content in nuts are given in the table below:

| Nut | Total Fat wt. % | SFA |
|---|---|---|
| Almond | 53 | 4 |
| Black Walnut | 59 | 3 |
| Brazil Nuts | 67 | 25 |
| Cashew | 46 | 9 |
| Hazelnut | 61 | 4 |
| Macadamia | 76 | 12 |
| Peanuts | 49 | 6 |
| Pistachio | 46 | 6 |

The nut-based coating composition according to the invention comprises 40-60 wt % of fat. This range of fat content is preferred, as it contributes to achieve appropriate viscosity and preferred thickness of coating in frozen confections, e.g. 0.4-4 mm thick.

The coating composition according to the invention comprises 50-60 wt % of non-fat solids. The non-fat solids are preferably selected from the group consisting of sugar, salt, cocoa, fibers, milk solids non-fat and one or more flavors. The non-fat solids provide structure, flavour and colour to the coating.

The coating composition may optionally comprise 10-20 wt. % non-fat milk solids.

The coating composition may comprise 5-45 wt. % sugar.

In the present context, the fat or fat phase includes the fat in nuts, vegetable oil, emulsifiers, optional structuring agents, and milk fractions. The fat in these components is calculated into the amounts of fat in the composition unless otherwise indicated.

In the present context, ganache is a term that describes a rich and creamy topping made with chocolate and heavy cream. It can be used in the centres of truffles, as a glaze over cake, or it can be whipped for use as filling and/or frosting. Traditionally, a ganache is made by heating cream and adding bits of chocolate. The mixture is then stirred until it becomes smooth.

The frozen confection may be a portion, dome, bonbon, morsel, stick, or bar. It can be extruded or molded. The frozen confection may be provided with a stick for holding the product.

In a preferred embodiment of the invention, the hardening fat in addition to the optional milk fat comprises fat selected from the group consisting of palm oil, palm mid fractions, palm kernel oil, cocoa butter, coconut oil, or a combination thereof.

In a preferred embodiment of the invention the liquid oil is selected from the group consisting of rapeseed oil (canola oil), sunflower oil, safflower oil, soybean oil, corn oil, algal oil, palm olein, peanut oil, olive oil, tree nut or culinary nut oil, moringa oleifera, seed oil, avocado oil or a combination thereof. In the context of peanut-based coating, it is preferred that the oil is peanut oil.

In a preferred embodiment of the invention, the coating composition has a solid fat content (SFC) of 30-50% at 0° C. To keep a soft texture while still being able to set fast a solid fat content at 0° C. of between 30-50% is preferred. Above 50% the coating becomes brittle and snaps or cracks. Below 30% the coating does not set. The present invention provides the benefit.

In a preferred embodiment of the invention, the coating composition comprises 40-60% fat, 15-30% non fat nut mass, and some seasoning such as salt and sugar to taste.)

In a preferred embodiment of the invention, the coating composition comprises 10-20 wt. % non-fat milk solids.

A preferred plastic viscosity of the coating composition has been found to be 100 to 700 centipoise (cps) (mPas) at 40° C. Below this value, the coating will be too thin, with a lower pick-up weight. With a thin coating, there would be a loss of desirable textural attributes.

Above the indicated plastics viscosity range “pin holes” or uneven coating are likely to occur on the products to be coated.

The melting point of the coating has been found to be important for the coating to set well and however at the same time it should not be too waxy when consumed. It is preferred that the coating composition has a melting point of 32 to 36° C. Below that temperature, it will not set and have run down issues and with oily mouthfeel of the coating and above that temperature, it will have a waxy sensorial properties. Waxy texture occurs when melting point is above 36° C.

The fat-based coating composition may comprise 0.1-2 wt. % of emulsifiers. Preferably, the emulsifiers are selected from the group consisting of but not limited PGPR (Polyglycerol polyricinoleate), mono di glycerides, sunflower lecithin and soy lecithin or a combination thereof based on the weight of the coating composition.

Emulsifier can be used to further regulate the viscosity of the coating. If so, preferred emulsifiers are soy lecithin and/or sunflower lecithin/canola lecithin, as they are perceived as cleaner label.

PGPR can be used to impacts yield value, and will affect thickness if so desired. PGPR is not used in some instances because it is not perceived as clean label.

The fat blend used in the composition according to the invention has a saturated fat level of below 40%, which equates 16-22% SFA in the coating.

The invention also relates to a process for producing a coating composition according to the invention. Embodiment of the coating compositions are described above. The process comprises the steps: providing whole ground nut, providing the non-fat solids, the hardening fat, and the liquid oil, melting the hardening fat, mixing non-fat solids with the at least part of the melted hardening fat and obtaining a mixture of fats, oils and non-fat solids, resulting in a paste, refining the mixture of fats, oils and non-fat solids by milling to reduce the particle size, preferably to a particle size below 80 microns, preferably below 40 to 15 microns, adding remaining fats and oils to the refined mixture and optionally adding emulsifier to the refined mixture and/or the mixture with fats and oils.

In an alternative process of the invention the non-fat solids can be pre-milled in a separate process-step (e.g. by the use of air-classifier mills). The pre-milling step can then fully or partly replace the refining of the mixture of fat and non-fat solids by milling to reduce the particle size.

In the present context particle size may be determined using the Malvern particle sizer, with medium chain triglyceride (MCT) oil as the dispersant. Particle size is analyzed at fraction less than 10%, 50%, 90% and are calculated with the Malvern software based on the Mie theory. In the context of this application, the particle sizes are values at 90%. Equipment that may be used is a Chocolate Particle Size Analyzer, Malvern Mastersizer Micro with size range: 0.3 μm to 300 μm.

The invention also relates to a frozen confection with at least partly coated frozen confection with a composition to the invention. Preferably, the frozen confection according to the present invention may have a coating thickness from 0.4 to 4 mm.

The invention also relates to a method for producing a frozen confection, the method comprising providing a coating composition as described in this patent application and applying the method of preparation according to the invention described herein.

The frozen confection according to the invention may in addition to the coating, comprise ice cream, water ice, frozen yoghurt, frozen dessert and the like. In a particular preferred embodiment, the frozen confection comprises jelly or jam, such as fruit jelly or jam. This provides a popular flavour combination known from toast or sandwich with peanut butter and jelly or jam. In an even more preferred embodiment of the frozen confection, it comprises the coating according to the invention, jelly or jam and ice cream.

### EXAMPLES

### Example 1

Sample Preparation:

Coating samples have been made by mixing the dry ingredients, the oils and emulsifiers to obtain a 5 kg batch. After mixing, the composition is ground in a mill (Royal Duyvis Wiener I-W-S; 8 mm steel balls) at 45° C. When grinding is over, flavoring agent were added to the composition and the mixture stirred at 150 rpm for 30 minutes.

Samples with the following recipes were prepared.

| | % |
|---|---|
| Soft, -non-setting coating | |
| Sugar | 41.000 |
| Soya Bean Oil | 37.250 |
| Vegetable Fat Palm (Stearin) | 1.350 |
| Cocoa Powder | 20.000 |
| Lecithin | 0.400 |
| Brittle, fast-setting | |
| Sugar | 31.000 |
| Coconut Oil | 50.000 |
| Canola Oil | 7.500 |
| Cocoa Powder | 11.000 |
| Lecithin | 0.500 |
| Soft peanut-butter coating | |
| Peanut Whole Ground | 30.80 |
| Palm Oil | 25.40 |
| Sugar | 25.00 |
| Skimmed Milk Powder | 14.60 |
| Anhydrous Milk Fat | 2.80 |
| Fully Hydrogenated Vegetable Oil | 0.70 |
| Salt | 0.40 |
| Lecithin | 0.30 |

The solid fat content (SFC) of samples was measured on a DSC2500 (TA Instruments) equipment using Tzero hermetic pans with the following cycle: equilibrate at 20° C., ramp 10° C./min to 80° C., isothermal 5 min, ramp 10° C./min to −40° C., isothermal 5 min, ramp 10° C./min to 80° C. The SFC computed on the thermogram of the second melt cycle. For reference, it was assumed that the SFC of the sample at −40° C. was 100% and that at 80° C. was 0%, and a running integral was calculated.

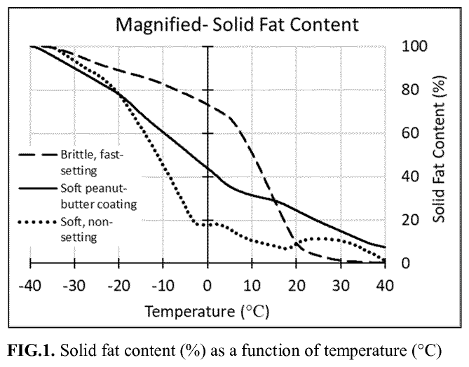

FIG. 1 shows the SFC % as a function of temperature. As seen here, the SFC profile of a brittle snap-coating is drastically different than a soft non-setting coating, however the SFC profile of the soft peanut-butter coating according to the invention falls in between. This indicates that the coating according to the invention has a more solid matrix than a non-setting coating at frozen food temperatures, and is less solid than a regular fast-setting coating. The present invention of coating sets quickly in the −20 to 0° C. range which makes it technically feasible to apply to frozen confections. At 0° C., the coating composition according to the invention has an SFC intermediate to the brittle and non-setting coating which was shown to be desirably soft yet structurally sound. Moreover, while warming up to ambient temperatures at the time of consumption, the intermediate solid fat levels keep the coating intact while providing a smoother mouthfeel.

The texture was measured using a TA.XT.plus texture profile analyser (Stable Micro Systems, UK). Samples were completely melted to erase crystal memory and then frozen in a 3 oz plastic sample cup for 8 hours at −22° C. Immediately prior to measurement, a sample was retrieved from the freezer and a single penetration test was conducted on the texture profile analyser with a 5 mm diameter stainless steel probe from a distance of 15 mm at 1 mm/s. The trigger force was set to 8 g.

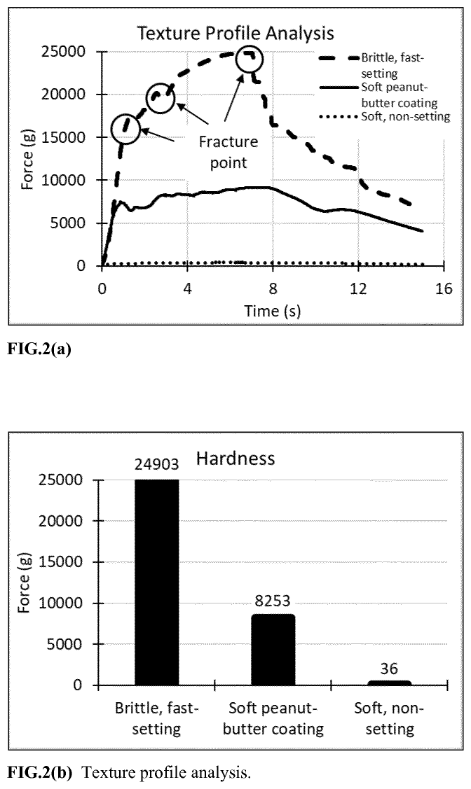

FIG. 2(a) shows the texture profile as a function of test time. In FIG. 2(a), the force (g) as a function of time in seconds is plotted and in FIG. 2(b) the hardness or peak force value is shown.

As seen in this figure, the regular fast-setting snap coating can withstand higher forces before breaking whereas the soft peanut-butter and the non-setting coating do not fracture.

Furthermore, the soft peanut butter coating according to the invention is approx. one-third as hard as the regular snap-coating, and yet dramatically harder than a typical soft non-setting coating.

### Example 2

Example 2 uses the peanut butter coating according to the invention and compares the analytical data to another nut-butter coating that does not work as a coating on frozen confections. The coatings are prepared as indicated in Example 1.

| | % |
|---|---|
| Soft peanut-butter coating | |
| Peanut Whole Ground | 30.80 |
| Palm Oil | 25.40 |
| Sugar | 25.00 |
| Skimmed Milk Powder | 14.60 |
| Anhydrous Milk Fat | 2.80 |
| Fully Hydrogenated Vegetable Oil | 0.70 |
| Salt | 0.40 |
| Lecithin | 0.30 |
| Non-setting peanut-butter coating | |
| Peanut Whole Ground | 31.07 |
| Soybean oil | 24.9 |
| Sugar | 25.69 |
| Skimmed Milk Powder | 14.80 |
| Anhydrous Milk Fat | 2.76 |
| Fully Hydrogenated Vegetable Oil | 0 |
| Salt | 0.46 |
| Lecithin | 0.32 |

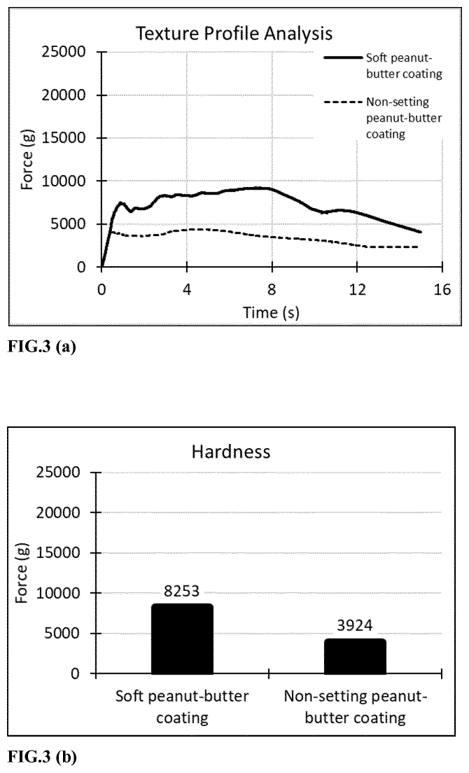

FIG. 3(a) shows the texture profile with time in a single penetration test at −22° C. FIG. 3(b) shows its peak hardness value (force, g) for fat-based coating according the invention compared with a coating containing nuts that does not set.

It should be understood that there are various changes and modifications to the presently preferred embodiments described herein which will be apparent to those skilled in the art. Such changes and modifications can be made without departing from the spirit and scope of the present subject matter and without diminishing its intended advantages. It is therefore intended that such changes and modifications be covered by the appended claims.

1. A frozen confectionery comprising a coating having a coating composition comprising, expressed in weight % (based on the total weight of the coating),
40-60 wt. % of total fat in the coating,
30-50 wt. % of ground whole nuts having a particle size below 80 microns, and
wherein the total fat in the coating composition comprises 40-60 wt. % of liquid fat and 60-40 wt. % of hardening fat based on the total fat.

2. A frozen confectionery according to claim 1, wherein the ground whole nuts are providing 23-61 wt. % of the total fat in the coating composition and
77-39 wt. % of the total fat not originating from the ground whole nuts together with the fat from the ground nuts provides the total fat in the coating composition.

3. A frozen confectionery according to claim 1, wherein the total fat in the coating composition comprises 45-55 wt. % of the liquid fat and 55-45 wt. % of hardening fat based on the total fat.

4. A frozen confectionery according to claim 1, wherein the ground whole nuts provide 14-23 wt. % of nut oil based on the total coating weight.

5. A frozen confectionery according to claim 1, wherein the coating composition comprises 14-45 wt. % non-fat solids not coming from the nuts and 15-26 wt. % non-fat solids coming from the nuts based on the total coating weight.

6. A frozen confectionery according to claim 1, wherein the fat not originating from the ground nuts comprises 16-0 wt. % liquid oil and 30-20 wt. % of hardening fat based on total coating weight.

7. A frozen confectionery according to claim 1, wherein the fat in coating composition in addition to the fat from the ground whole nuts is combined with an ingredient selected from the group consisting of dairy fat, palm oil, coconut oil, palm mid fractions, palm kernel oil, cocoa butter, and a combination thereof.

8. A frozen confectionery according to claim 1, wherein the coating composition before it is frozen coating composition has a plastic viscosity of 100 to 700 centipoise (cps) (mPas) at 40° C.

9. A frozen confectionery according to claim 1, wherein the coating composition has a solid fat content of 30-50% at 0° C.

10. A frozen confectionery according to claim 1, wherein the coating composition comprises a structuring agent in an amount of between about 0.2% and 3% by weight of the coating composition.

11. A frozen confectionery according to claim 1, wherein the hardening fat in the coating composition comprises fat selected from the group consisting of milk fat, palm oil, palm oil mid fractions, palm kernel oil, coconut oil, cocoa butter and a combination thereof.

12. A frozen confectionery according to claim 1, wherein the liquid oil in the coating composition is selected from the group consisting of: rapeseed oil (canola oil), sunflower oil, safflower oil, soybean oil, corn oil, algal oil, palm olein, peanut oil, olive oil, tree nut or culinary nut oil, moringa oleifera, seed oil, avocado oil and a combination thereof.

13. A frozen confectionery according to claim 1, wherein the non-fat solids, not coming from the nuts in the coating composition, are selected from the group consisting of: sugar, salt, cocoa, fibers, milk solids non-fat and one or more flavors.

14. A frozen confectionery according to claim 1, wherein the coating composition comprises 0.1-2 wt. % of emulsifiers selected from the group consisting of PGPR, mono di glycerides, sunflower lecithin and soy lecithin and a combination thereof based on the weight of the coating composition.

15. A frozen confectionery according to claim 1, wherein the non-fat solids in the coating composition comprises 5-45 wt. % sugar.

16. A frozen confectionery according to claim 1, wherein the ground whole nuts are selected from the group consisting of peanuts, almonds, brazil nuts, cashews, hazel nuts, pecans, walnuts, macadamia nuts, pistachio, chest nuts, other culinary nuts, and mixtures thereof.

17. A process for producing a coating composition, wherein the process comprising the steps:
providing whole ground nut,
providing the non-fat solids, the hardening fat, and the liquid oil,
melting the hardening fat,
mixing non-fat solids with the at least part of the melted hardening fat and obtaining a mixture of fats, oils and non-fat solids, resulting in a paste,
refining the mixture of fats, oils and non-fat solids by milling to reduce the particle size, to a particle size below 80 microns,
adding remaining fats and oils to the refined mixture, and
adding emulsifier to the refined mixture and/or the mixture with fats and oils.
